(19) United States
(12) Patent Application Publication
(10) Pub. No.: US 2020/0270794 A1
(43) Pub. Date: Aug. 27, 2020

(54) LAUNDRY TREATMENT APPARATUS

(71) Applicant: QINGDAO HAIER DRUM WASHING MACHINE CO., LTD., Shandong (CN)

(72) Inventors: Wenwei LI, Shandong (CN); Benfu XING, Shandong (CN); Jun WU, Shandong (CN); Yubao WANG, Shandong (CN); Jinkai WANG, Shandong (CN)

(73) Assignee: QINGDAO HAIER DRUM WASHING MACHINE CO., LTD., Shandong (CN)

(21) Appl. No.: 16/646,331

(22) PCT Filed: Sep. 4, 2018
(86) PCT No.: PCT/CN2018/103875

§ 371 Date: Mar. 11, 2020

(30) Foreign Application Priority Data
Sep. 13, 2017 (CN) 201710822128.X

(51) Int. Cl. D06F 29/00; D06F 37/28; D06F 21/04; D06F 34/34; E06B 7/28

(52) U.S. Cl. CPC D06F 29/005; D06F 37/28; E06B 7/28; D06F 34/34; D06F 21/04

(57) ABSTRACT

A laundry treatment apparatus includes a first laundry treatment drum and a second laundry treatment drum disposed up and down, and a front panel located in front of the first laundry treatment drum and the second laundry treatment drum and covering the first laundry treatment drum and the second laundry treatment drum. A first door and a second door are disposed on the front panel up and down. A control panel assembly is disposed on at least one of the first door and the second door. According to the characteristics of a twin-drum laundry treatment apparatus, the control panel assembly is disposed on the first door higher, which is convenient for the user to view the screen of the control panel assembly and further facilitates the user to input control instruction from the control panel. The structural design is more suitable for the twin-drum laundry treatment apparatus.

### TECHNICAL FIELD

The present disclosure relates to the field of home appliances and in particular to a laundry treatment apparatus provided with a control panel assembly on a door.

### BACKGROUND

With the development of the society, people have increasing requirements on product appearance and using comfort of home appliances. In the fiercely competitive sales of home appliances, people select home appliances with structural design that they like. The structural design of a home appliance influences whether the home appliance is sold well or not.

As the living quality improves, people seek for increasing high quality fine life. The clothes dryer has entered more and more ordinary families, and has become one of essential home appliances for high quality living. In an ordinary family, a clothes dryer is usually stacked on a drum washing machine to form a simply stacked whole. However, since the clothes dryer and the washing machine are operated respectively with independent control systems, user operations are not convenient. Moreover, the control panel of the clothes dryer is disposed at the upper part of the door of the clothes dryer, such that the height of the control panel is too high, thereby causing disadvantages for a short user to view and operate it. Meanwhile, a front panel of an existing laundry treatment apparatus is generally designed as a plane structure perpendicular with the ground. When the control panel is disposed on the front panel, it is disadvantageous for a user to operate the control panel. Particularly, a high-grade laundry treatment apparatus is provided with a touch display screen. If the touch display screen is disposed on the front panel, the display screen is mounted vertically, which is disadvantageous for the user to check information displayed on the touch display screen and further disadvantageous for the user to input a control instruction. In order to realize view of the display screen from a user perspective, it is required to dispose the touch display screen in a tilting manner. However, a design method in the prior art is to dispose a control panel assembly on a top cover of a laundry treatment apparatus, such that a user can overlook a display screen of the control panel assembly. However, the height of a twin-drum washing machine is too high. If the control panel assembly is disposed on a top cover, it is disadvantageous for an ordinary user to view a display screen of the control panel assembly and further disadvantageous for an ordinary user to input a control instruction on the control panel assembly.

In view of this, the present disclosure is hereby proposed.

### SUMMARY

The technical problem to be solved in the present disclosure is to overcome the defects of the prior art and provide a laundry treatment apparatus. According to the characteristics of a twin-drum laundry treatment apparatus, a control panel assembly is disposed on a higher door, which is convenient for the user to view the screen of the control panel assembly and further facilitates the user to input control instruction from the control panel. The structural design is more suitable for the twin-drum laundry treatment apparatus, and the user experience is better.

In order to solve the above technical problem, the basic conception of the technical solution adopted in the present disclosure is:

A laundry treatment apparatus includes a first laundry treatment drum and a second laundry treatment drum disposed up and down, and a front panel located in front of the first laundry treatment drum and the second laundry treatment drum and covers the first laundry treatment drum and the second laundry treatment drum, wherein

a first door and a second door are disposed on the front panel up and down, and a control panel assembly is disposed on at least one of the first door and the second door.

In the above solution, according to the characteristics of a twin-drum laundry treatment apparatus, the control panel assembly is disposed on the higher door, which is convenient for the user to view the screen of the control panel assembly and further facilitates the user to input the control instruction from a control panel. The structural design is more suitable for the twin-drum laundry treatment apparatus and the user experience is better.

Preferably, the first door or the second door includes a door body and an observation window mounted at a hollow position on the door body, the door body is provided with a mounting space above the observation window, and the control panel assembly is mounted in the mounting space higher than the observation window.

In the above solution, the mounting position of the control panel assembly is higher than the observation window, thus not influencing the user to view the situation inside the laundry treatment apparatus.

Preferably, the door body includes an outer frame and an inner frame, which are mounted integrally to constitute a main frame of the first door or the second door, a port is arranged on a center positions of the outer frame and the inner frame for mounting the observation window, and a groove is arranged in the outer frame and the inner frame above the ports to form the mounting space for mounting the control panel assembly.

Preferably, the door body further includes a window screen covering the surface of the outer frame and shielding the outer surface of the first door or the second door, an opening corresponding to the groove in the outer frame is arranged on an upper part of the window screen, and the control panel assembly includes a control panel mounted in the opening.

In the above solution, the control panel of the control panel assembly is mounted in the opening and fixed to the window screen, resulting in delicate outlook and appropriate height, which facilitate the users to view and operate.

Preferably, the control panel assembly includes a shell with an opening, a control panel disposed at an open end of the shell, and a computer board mounted in the shell, and the control panel extends into the mounting space through the groove in the inner frame and is mounted and fixed in the opening of the window screen.

Preferably, the surface of the shell, opposite to the control panel, protrudes outward to form a fixing portion, a surface of circumferential side of the groove in the inner frame is sunk inwards to form a mounting portion for holding and fixing the fixing portion, and the fixing portion is attached to the interior of the mounting portion and is fixed to the mounting portion through a fastener.

Preferably, the fixing portion is of a laminar structure, and the thickness of the fixing portion is matched with a depth of the mounting portion sunk inward to ensure that when the fixing portion is mounted on the mounting portion, a surface of the control panel assembly exposed out of the outer frame is in smooth transition with the surface of the outer frame.

Preferably, the front panel is of a one-piece tabular structure covering the first laundry treatment drum and the second laundry treatment drum, a mounting space is disposed on the first door, the control panel assembly is embedded in the mounting space and is fixed to the first door, and the surface of the control panel assembly is in smooth transition with the surface of the first door.

In the above solution, the outer surface, exposed out of the first door, of the control panel assembly is in smooth transition with the outer surface of the first door, and the inner surface, exposed out of the first door, of the control panel assembly is in smooth transition with the inner surface of the first door. Through the structural design, no matter whether the first door is closed or opened, the control panel assembly is integrated with the first door visually, resulting in delicate outlook and good texture.

Preferably, a laundry input port is disposed on the front panel, the circumferential surfaces of the laundry input port are recessed to form door mounting spaces, the doors of the laundry treatment apparatus are embedded in the door mounting spaces and are connected with the front panel for allowing the laundry input port to be opened or closed, and the doors of the laundry treatment apparatus, the control panel and the front panel form a smooth front surface of the laundry treatment apparatus.

In the above solution, the front panel is provided with a first door mounting space and a second door mounting space corresponding to the first laundry treatment drum and the second laundry treatment drum respectively, and the control panel assembly is mounted on the first door.

Preferably, a cross-sectional profile of the front panel from top to bottom is a smooth line gradual transition from a curve to a straight-line segment occurs, the surfaces of the doors are in smooth transition with the front panel at the circumferential sides of the doors, and the control panel of the control panel assembly is in smooth transition with the surface of the first door.

In the above solution, the control panel is a touch display screen, and includes a touch display screen body and a touch film covering the surface of the touch display screen body, and the touch film is in smooth transition with the surface of the first door.

Preferably, at least a part of the first door is disposed as a curved-surface structure bent towards the back side of the laundry treatment apparatus or a plane structure tilting towards the back side of the laundry treatment apparatus; and the control panel assembly is shared by the first laundry treatment drum and the second laundry treatment drum and is disposed on the curved-surface structure or the plane structure.

Preferably, the curved-surface structure on the first door is located at an upper part of the door, the first door is provided with a plane structure or curved-surface structure below the curved-surface structure, the control panel assembly is disposed on the curved-surface structure at the upper part of the first door, and the surface of the control panel assembly has the same curvature or tilt angle with the surface of the first door at the circumferential side of the control panel assembly.

After the above technical solution is adopted, the present disclosure has the following beneficial effects as compared with the prior art:

1. In the present disclosure, according to the characteristics of a twin-drum laundry treatment apparatus, the control panel assembly is disposed on the higher first door, which is convenient for the user to view the screen of the control panel assembly and simultaneously further facilitates the user to input control instruction from a control panel. The structural design is more suitable for the twin-drum laundry treatment apparatus, and the user experience is better.

2. In the present disclosure, the front panel is of a one-piece tabular structure covering the first laundry treatment drum and the second laundry treatment drum, the mounting space is disposed on the first door, and the control panel assembly is embedded in the mounting space and is fixed to the first door. The surface, exposed out of the first door, of the control panel assembly is in smooth transition with the surface of the first door, the outer surface, exposed out of the first door, of the control panel assembly is in smooth transition with the outer surface of the first door, and the inner surface, exposed out of the first door, of the control panel assembly is in smooth transition with the inner surface of the first door. Through the structural design, no matter whether the first door is closed or opened, the control panel assembly is integrated with the first door visually, resulting in delicate outlook and good texture.

3. In the present disclosure, the control panel assembly includes a shell with an opening, a control panel disposed at the open end of the shell, and a computer board mounted in the shell, and the control panel extends into the mounting space through the groove in the inner frame and is mounted and fixed on the opening of the window screen. The surface of the shell, opposite to the control panel, protrudes towards the circumferential side to form a fixing portion, the surface of circumferential side of the groove in the inner frame is sunk inwards to form a mounting portion for holding and fixing the fixing portion, and the fixing portion is attached to the interior of the mounting portion and is fixed to the mounting portion through a fastener. Preferably, the fixing portion is of a laminar structure, and the thickness of the fixing portion is matched with the depth of the mounting portion inward sunk to ensure that when the fixing portion is mounted on the mounting portion, the surface, exposed out of the outer frame, of the control panel assembly is in smooth transition with the surface of the outer frame.

4. In the present disclosure, the surface of the upper part of the first door is designed as a curved-surface structure bent towards the back side of the laundry treatment apparatus or a plane structure tilting towards the back side of the laundry treatment apparatus; the control panel assembly is shared by the first laundry treatment drum and the second laundry treatment drum and is disposed on the curved-surface structure or the plane structure, thus ensuring that the control panel tilts towards the back of the laundry treatment apparatus, to facilitate the user to view and operate the control panel.

Specific implementations of the present disclosure will be further described in details in conjunction with the drawings.

### BRIEF DESCRIPTION OF THE DRAWINGS

Drawings, as a part of the present application, are used for providing further understanding of the present disclosure. Illustrative embodiments of the present disclosure and description thereof are used for interpreting the present disclosure, yet without constituting undue limitation to the present disclosure. Obviously, the drawings described below are merely some embodiments. Under the precondition of not paying any inventive labor, those skilled in the art can further obtain other drawings according to these drawings.

In the drawings,

FIG. 1 is a structural schematic diagram of a door of a laundry treatment apparatus of the present disclosure;

FIG. 2 is a back-side view of FIG. 1;

FIG. 3 is an exploded view of FIG. 1;

FIG. 4 is a stereostructure schematic diagram of a laundry treatment apparatus of the present disclosure;

FIG. 5 is a side view of FIG. 4;

FIG. 6 is a front view of FIG. 4;

FIG. 7 is a schematic diagram of a front panel in FIG. 4; and

FIG. 8 is a side view of FIG. 7.

In the drawings, 2—Control panel assembly, 3—Door body, 31—Window screen, 32—Outer frame, 33—Inner frame, 34—Observation window, 311—Opening, 321—Groove, 21—Touch film, 22—Touch display screen body, 23—Computer board, 24—Shell, 25—Fixing portion, 10—Front panel, 11—First laundry input port, 12—Second laundry input port, 13—Curved-surface structure, 14—Tilting or vertical plane structure, 15—First combined surface, 16—Second combined surface, 17—Third combined surface, 19—Annular groove, 20—Side plate, 40—Countertop, 50—First door, 60—Second door and 70—Filter port.

It should be noted that these drawings and written description are not aimed at restricting the scope of conception of the present disclosure in any manner, but at describing the concepts of the present disclosure for those skilled in the art by referring to specific embodiments.

### DETAILED DESCRIPTION

In order to enable the purpose, the technical solution and advantages of the embodiments of the present disclosure to be clearer, the technical solutions in embodiments of the present disclosure will be completely and clearly described below in conjunction with drawings in embodiments of the present disclosure. The embodiments below are used for description of the present disclosure, yet without restricting the scope of the present disclosure.

In the description of the present disclosure, it should be noted that the orientation or position relationship indicated by terms like “up”, “down”, “inner” and “outer” is orientation or position relationship indicated based on drawings, just for facilitating description of the present disclosure and simplifying the description, rather than indicating or hinting that the device or element indicated must have a specific orientation and must be configured and operated at a specific orientation. Thus, it cannot be understood as restriction to the present disclosure.

In the description of the present disclosure, it should be noted that unless otherwise prescribed and defined clearly, terms like “mounting” and “connection” should be understood in a broad sense. For example, it may be fixed connection and may also be detachable connection or integral connection; it may be mechanical connection and may also be electrical connection; it may be direct connection and may also be indirect connection through an intermediary. For those skilled in the art, the specific meanings of the above terms in the present disclosure can be understood depending on specific situations.

### Embodiment I

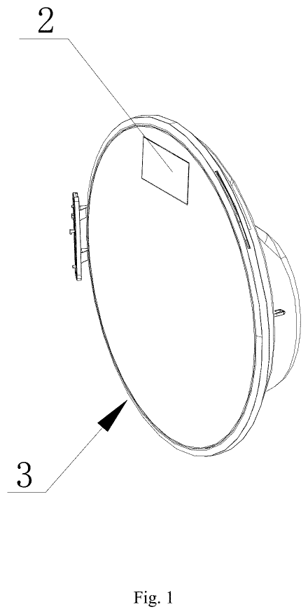

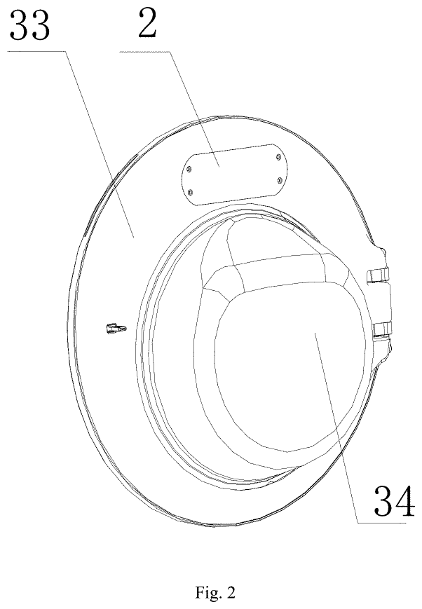

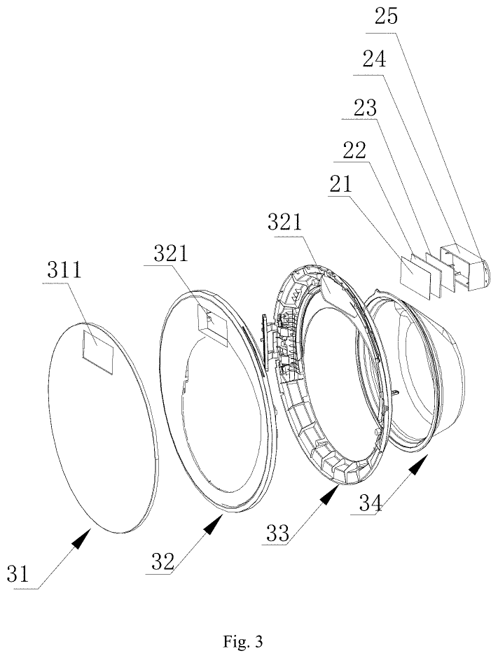

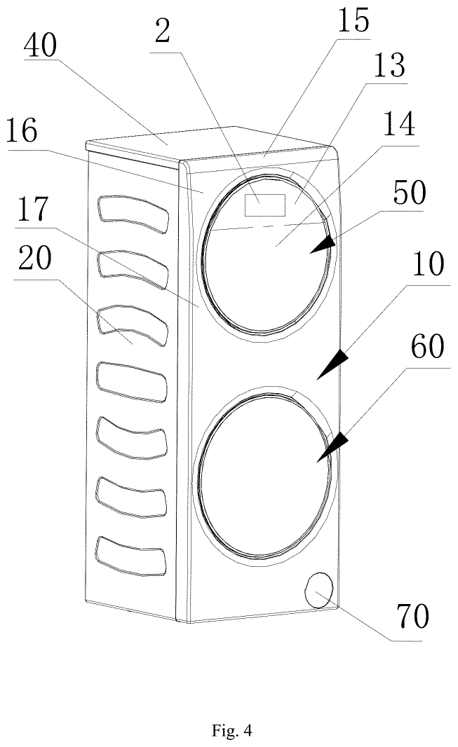

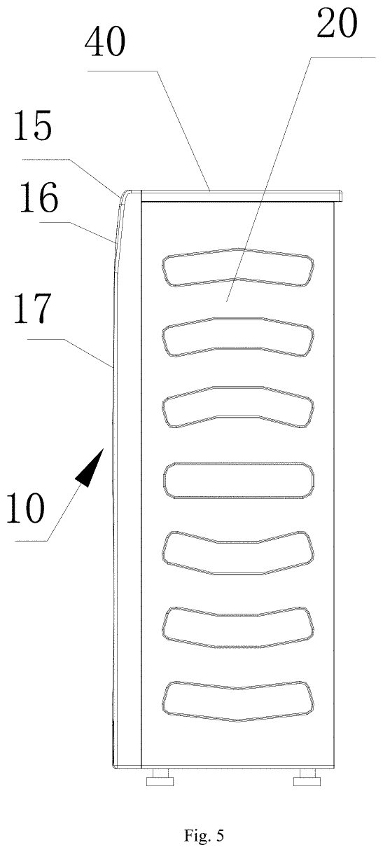

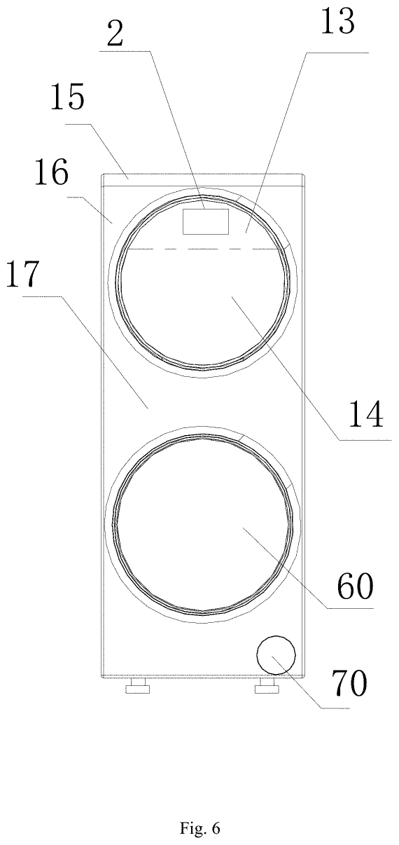

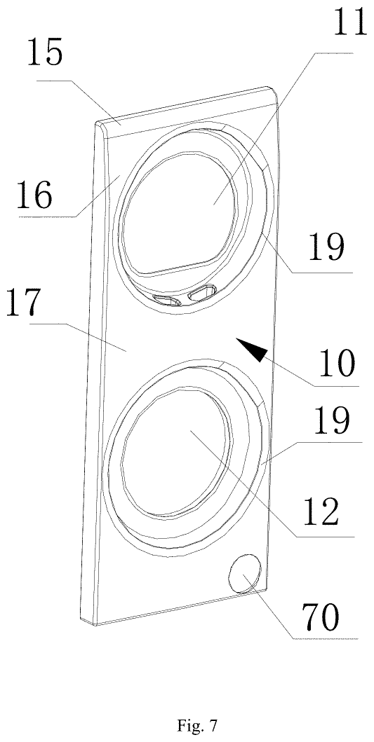

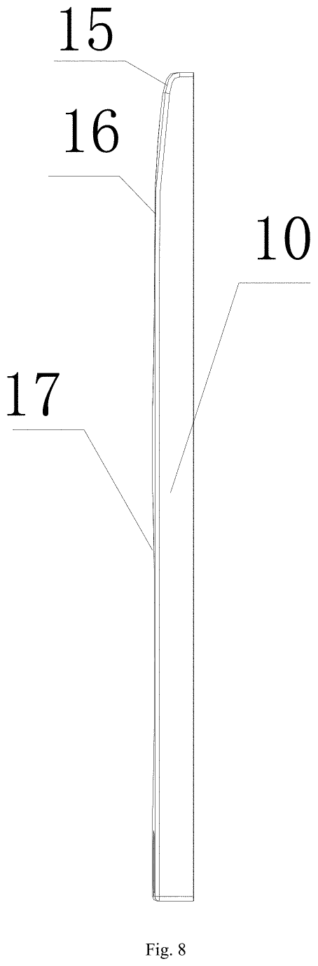

Referring to FIGS. 1-8, the embodiment provides a laundry treatment apparatus which includes a first laundry treatment drum and a second laundry treatment drum which are disposed up and down, and a front panel 10 which is located in front of the first laundry treatment drum and the second laundry treatment drum and covers the first laundry treatment drum and the second laundry treatment drum. A first door 50 and a second door 60 are disposed on the front panel 10 up and down, and a control panel assembly 2 is disposed on at least one of the first door and the second door.

In the embodiment, a first control panel assembly may be disposed on the first door 50, a second control panel assembly may be disposed on the second door 60. The first control panel assembly includes a control panel, which is a touch display screen for displaying the working state of the first laundry treatment drum and receiving the control instruction input by the users, and the second control panel assembly is also provided with a control panel for displaying the working state of the second laundry treatment drum and receiving the control instruction input by the users. Disposing of the control panel assemblies 2 on the first door 50 and the second door 60 respectively is strongly targeted, as a control instruction for controlling the first laundry treatment drum can be visually input through the control panel on the first door 50, and the working state of the first laundry treatment drum can be viewed; and a control instruction for controlling the second laundry treatment drum can be input through the control panel on the second door 60 and the working state of the second laundry treatment drum can be viewed.

The laundry treatment apparatus of the embodiment is preferably provided with one control panel assembly 2 only, and the control panel assembly is disposed on the first door 50 at a higher position. The height is fit with the height of the public, which is advantageous for the users to use it. A door of the laundry treatment apparatus is connected to the front panel 10 through a hinge, and the control panel assembly 2 is electrically connected with an electrical element in the laundry treatment apparatus through wire harness in the hinge.

In the above solution, according to the characteristics of a twin-drum laundry treatment apparatus, the control panel assembly 2 is disposed on the higher first door 50, which is convenient for the user to view the screen of the control panel assembly 2 and simultaneously further facilitates the users to input control instruction from a control panel. The structural design is more suitable for the twin-drum laundry treatment apparatus, and the user experience is better.

Preferably, the first door 50 or the second door 60 includes a door body 3 and an observation window 34 mounted at a hollow position on the door body 3, the door body 3 is provided with a mounting space above the observation window 34, and the control panel assembly 2 is mounted in the mounting space at a position higher than the observation window 34.

In the above solution, the mounting position of the control panel assembly 2 is higher than the observation window 34, thus not influencing a user's view of the situation inside the laundry treatment apparatus. Of course, a control panel of the control panel assembly 2 may also be disposed on the observation window 34 of the door, and only shield a part of the surface of the observation window 34.

Preferably, the door body 3 includes an outer frame 32 and an inner frame 33, which are mounted integrally to constitute a main frame of the first door or the second door. A port is arranged on a center positions of the outer frame 32 and the inner frame 33 for mounting the observation window 34, and the outer frame 32 and the inner frame 33 are correspondingly provided with grooves 321 above the port to form the mounting space for mounting the control panel assembly 2.

Preferably, the door body 3 further includes a window screen 31 covering the surface of the outer frame 32 and shielding the outer surface of the entire door. The upper part of the window screen 31 is provided with an opening 311 corresponding to the groove 321 in the outer frame 32, and the control panel assembly 2 includes a control panel mounted in the opening 311.

In the above solution, the control panel of the control panel assembly 2 is mounted in the opening 311 and is fixed to the window screen 31, resulting in dedicated outlook and appropriate height, which facilitate the user's view and operation.

Preferably, the control panel assembly 2 includes a shell 24 with an opening, a control panel disposed at the open end of the shell 24, and a computer board 23 mounted in the shell, and the control panel extends into the mounting space through the groove 321 in the inner frame 33 and is mounted and fixed on the opening 311 of the window screen 31.

Preferably, the shell 24 is clamped and fixed in the mounting portion, or the shell 24 is fixed in the mounting portion through a fastener.

Preferably, the surface of the shell 24, opposite to the control panel, protrudes towards the circumferential side to form a fixing portion 25, the surface of circumferential side of the groove 321 in the inner frame 33 is sunk inwards to form a mounting portion for holding and fixing the fixing portion, and the fixing portion 25 is attached to the interior of the mounting portion and is fixed to the mounting portion through a fastener.

Preferably, the fixing portion 25 is of a laminar structure, and the thickness of the fixing portion 25 is matched with the depth of the mounting portion inward sunk, thus ensuring that when the fixing portion is mounted on the mounting portion, the surface, exposed out of the outer frame 32, of the control panel assembly 2 is in smooth transition with the surface of the outer frame.

### Embodiment II

Referring to FIGS. 1-8, Embodiment II further defines on the basis of Embodiment I that the front panel 10 is of a one-piece tabular structure covering the first laundry treatment drum and the second laundry treatment drum, a mounting space is disposed on the first door 50, the control panel assembly 2 is embedded in the mounting space and is fixed to the first door 50. And the surface, exposed out of the first door 50, of the control panel assembly 2 is in smooth transition with the surface of the first door 50.

In the above solution, the outer surface, exposed out of the first door 50, of the control panel assembly 2 is in smooth transition with the outer surface of the first door 50, and the inner surface, exposed out of the first door 50, of the control panel assembly 2 is in smooth transition with the inner surface of the first door 50. Through the structural design, no matter whether the first door 50 is closed or opened, the control panel assembly 2 is integrated with the first door 50 visually, resulting in delicate outlook and good texture.

In the embodiment, the defined first laundry treatment drum and the second laundry treatment drum may be a laundry drying drum and may also be a laundry washing drum or one is a laundry drying drum and the other is a laundry washing drum, wherein the front panel 10 is designed as a one-piece tabular structure, thus resulting an integrated outlook effect for a complete machine of the device for processing laundry.

Preferably, a laundry input port is disposed in the front panel 10, the circumferential surfaces of the laundry input port are recessed to form door mounting spaces, the doors of the laundry treatment apparatus are embedded in the door mounting spaces and are connected with the front panel 10 for allowing the laundry input port to be opened or closed, and the doors of the laundry treatment apparatus, the control panel and the front panel 10 form a smooth front surface of the laundry treatment apparatus.

In the above solution, the front panel 10 is provided with a first door mounting space and a second door mounting space corresponding to the first laundry treatment drum and the second laundry treatment drum respectively, the laundry treatment apparatus includes a first door 50 and a second door 60, the first door 50 is mounted in the first door mounting space, the second door 60 is mounted in the second door mounting space, and the control panel assembly 2 is mounted on the first door 50.

Preferably, a cross-sectional profile of the front panel 10 from top to bottom is a smooth line where gradual transition from a curve to a straight-line segment occurs, the surfaces of the doors are in smooth transition with the front panel 10 at the circumferential sides of the doors, and the control panel of the control panel assembly 2 is in smooth transition with the surface of the first door 50.

In the above solution, the upper part of the front panel 10 is disposed as a curved-surface tilting structure, thus it is advantageous for a user to observe and operate the laundry treatment apparatus. Moreover, the design of a curved-surface structure for the front panel 10 makes the laundry treatment apparatus present contemporary sense and design sense better.

In the above solution, the control panel is a touch display screen and includes a touch display screen body 22 and a touch film 21 covering the touch display screen body 22, the touch film 21 is in smooth transition with the surface of the first door 50.

Preferably, at least a part of the first door 50 is disposed as a curved-surface structure 13 bent towards the back side of the laundry treatment apparatus or a plane structure tilting towards the back side of the laundry treatment apparatus; the control panel assembly 2 is shared by the first laundry treatment drum and the second laundry treatment drum and is disposed on the curved-surface structure 13 or the plane structure.

Preferably, the curved-surface structure 13 on the first door 50 is located at the upper part of the door, the first door 50 is provided with a plane structure or curved-surface structure below the curved-surface structure 13. The control panel assembly 2 is disposed on the curved-surface structure 13 at the upper part of the first door 50, and the surface of the control panel assembly has the same curvature or tilt angle with the surface of the first door 50 at the circumferential side of the control panel assembly.

In the above solution, the curved-surface structure 13 is disposed at the upper part of the first door 50, the control panel assembly 2 is disposed on the curved-surface structure 13, and the control panel of the control panel assembly has the same curvature or tilt angle with the surface of the curved-surface structure, thus ensuring that the control panel tilts towards the back of the laundry treatment apparatus, which facilitates the user to view and operate the control panel.

Preferably, the front panel 10 includes a first combined surface 15, a second combined surface 16 and a third combined surface 17 in sequence from top to bottom. A cross-sectional profile of the third combined surface 17 in the vertical direction is a straight-line segment or an arc with a curvature of a. A cross-sectional profile of the second combined surface 16 in the vertical direction is a straight-line segment or an arc with a curvature greater than a. And the first combined surface 15 is a curved surface transitioning to a countertop 40 through a round corner from the top of the second combined surface 16.

Preferably, the first combined surface 15 is in smooth connection to the second combined surface 16, and the second combined surface 16 is in smooth connection to the third combined surface 17.

Preferably, a is 0 or close to 0.

Preferably, a cross-sectional profile of the second combined surface 16 in the horizontal direction is an arc with the middle part being convex and two sides being in smooth transition to side plates 20 respectively.

Preferably, a cross-sectional profile of the first combined surface 15 in the horizontal direction is also an arc with the middle part being convex and two sides being in smooth transition to the side plates 20 respectively, and a cross-sectional profile of the third combined surface 17 in the horizontal direction is also an arc with the middle part being convex and two sides being in smooth transition to the side plates 20 respectively.

Preferably, the third combined surface 17 is disposed perpendicular with a horizontal plane or disposed in a manner of forming a certain included angle with the horizontal plane. The second combined surface 16 is of a curved-surface structure with tilt greater than that of the third combined surface 17. The first door 50 is disposed between the second combined surface 16 and the third combined surface 17, the upper surface of the first door 50 is matched with the second combined surface 16 in curvature, and the lower surface of the first door 50 is matched with the third combined surface 17 in curvature.

Preferably, the third combined surface 17 is disposed perpendicular with the horizontal plane.

Preferably, the upper surface and the lower surface of the first door 50 are in smooth transition to form a transition line, the transition line is higher than the central position of the first door 50, the control panel assembly 2 is disposed on the first door 50 and located above the transition line, and the control panel of the control panel assembly is higher than the transition line.

### Embodiment III

Embodiment III further defines Embodiment I and Embodiment II. In Embodiment III, a laundry treatment apparatus similarly includes a first laundry treatment drum and a second laundry treatment drum which are disposed up and down, and a drying module for providing drying air to the laundry treatment drum to dry clothes is further disposed in the laundry treatment apparatus.

Further, the drying module is a condenser drying module, which includes a base, a condenser disposed on the base, and a cooling air channel disposed on the base and used for cooling the condenser. The condenser is connected with a drying air channel of the laundry treatment apparatus, and one side plate 20 or a back cover plate of a washing machine cabinet is provided with an air inlet for feeding air to the cooling air channel. By disposing the air inlet for the cooling air channel on the side plate 20 or the back cover plate of the laundry treatment apparatus, the integral structure of the front panel 10 of the complete machine is reserved, so as to make the front panel 10 integrated, which is advantageous to make the front panel 10 delicate and performs a function of obviously improving the aesthetic property of the laundry treatment apparatus. Meanwhile, disposing the air inlet on the side plate 20 or the back cover plate is advantageous to enhance the structural strength of the front panel 10.

Preferably, the cooling air channel includes a spiral case mounted on the base and close to the side plate 20, provided with the air inlet, of the cabinet. An air inlet port of the spiral case is disposed opposite to the air inlet. The shape of the air inlet may be round and may also be square, and the air inlet port of the spiral case and the air inlet are concentric, thus improving the air-in efficiency of the air inlet.

Preferably, the cooling air channel further includes an air channel upper shell mounted on the base, and an air channel for enabling an air outlet port of the spiral case to communicate with the condenser is formed between the air channel upper shell and the base.

Preferably, a condenser mounting groove and a recess gradually extending from the air outlet port of the spiral case to the condenser mounting groove are formed on the base, and the air channel upper shell is mounted at the tops of the recess and the condenser mounting groove to form the cooling air channel.

In the above solution, the arrangement of the recess on the base is advantageous to lower the mounting height of the condenser and reduce the internal space of the laundry treatment apparatus occupied by the base and the condenser.

Preferably, the air channel upper shell includes a first shell covering the condenser and a second shell connected with the first shell, covering the top of the recess and used for enabling the air outlet port of the spiral case to communicate with the condenser.

In the above solution, by dividing the air channel upper shell into the first shell and the second shell which are mutually connected, the structure of the air channel is made simple. The first shell is disposed and designed as a flared structure which is advantageous to diffuse cooling air to the entire condenser, while the second shell is designed as a box structure disposed in the length direction of the condenser. The end, connected with the spiral case, of the first shell is a small-mouth end, while the end, connected with the second shell, of the first shell is a flared wide-mouth end, so as to be advantageous to cool the condenser thoroughly with cooling air and improve the drying effect for the wet and hot air.

The first shell is matched with the structure of the condenser, and the second shell is matched with the structure of the recess.

In the above solution, the first shell is designed as a box structure disposed in the length direction of the condenser, while the recess is designed as a trapezoid structure with the gradually expanded air channel, and the second shell is designed as a trapezoid shell structure matched with the recess in shape and is mounted on the top of the recess.

Preferably, the spiral case further includes the air outlet port, which is disposed opposite to the air inlet port of the spiral case, and the second shell is disposed in a manner of extending in the direction of the air outlet port of the spiral case.

In the above solution, the spiral case is designed in a manner that the air inlet port faces one side plate 20 of the laundry treatment apparatus, while the air outlet port is in a direction opposite to the air inlet port, i.e. the air outlet port of the spiral case is disposed in a manner of facing another side plate 20 of the laundry treatment apparatus. The air-in end of the second shell is connected to the air outlet port of the spiral case and disposed in a manner of extending in the direction of the air outlet port of the spiral case, so as to reduce the flowing resistance of cooling air and improve the condenser cooling efficiency.

Preferably, an air outlet for exhausting air in heat exchange with the condenser out of the cooling air channel is disposed on the side plate 20 or the back cover plate and directly faces the condenser, or the air outlet of the cooling air channel is disposed in the shell to directly exhaust air after heat exchange to the spaces between the shell and the clothes treating drums.

In the above solution, disposing the air outlet corresponding to the position of the condenser reduces the flowing resistance of the cooling air and improves the condenser cooling efficiency. Meanwhile, it is also advantageous to reduce the energy consumption of the blower of the spiral case. Preferably, the shell is not provided with the air outlet of the cooling air channel, so that it is advantageous to enhance the structural strength of the shell.

Preferably, the air inlet is disposed on the side plate 20 at one side of the shell, and the air outlet is disposed on the side plate 20 at the other side of the shell.

Preferably, an air adjusting and filtering device is disposed on the air inlet and/or the air outlet.

Preferably, the inlet air adjusting and filtering device is of a louver structure.

Preferably, the base is mounted between the first laundry treatment drum and the second laundry treatment drum.

In the above solution, according to the characteristics of a twin-drum washing machine, disposing the base between the first laundry treatment drum and the second laundry treatment drum saves the internal space of the laundry treatment apparatus. As compared with disposing of the base on the bottom of a laundry drying drum in the prior art, disposing the base between the first laundry treatment drum and the second laundry treatment drum increases the mounting height of the condenser to facilitate mounting and dismounting of the condenser.

Further, the laundry treatment apparatus includes a back support, on which the back ends of the clothes treating drums are mounted, and the laundry treatment drum is communicated with the condenser drying module. An opening for allowing the condenser to be inserted therein to be mounted on the base is formed in the back support. In the embodiment, by disposing the opening at the back side of the laundry treatment apparatus, an integral structure of the front panel 10 of the complete machine is reserved to make the front panel 110 integrated, which is advantageous to make the front panel 10 delicate and performs a function of obviously improving the atheistic property of the laundry treatment apparatus. Meanwhile, disposing the opening in the back support is advantageous to enhance the structural strength of the front panel 10.

Preferably, a condenser fixing base is disposed on the opening. When the condenser is inserted in the opening and mounted on the base, the condenser fixing base is used for fixing the condenser.

In the above solution, the condenser fixing base is matched with the corresponding end of the condenser in shape. When the condenser is mounted on the base, the condenser fixing base is hermetically connected with the corresponding end of the condenser to prevent drying air from leaking.

Preferably, the condenser fixing base is an independent piece, and is fixed to the opening of the back support through a fastener.

Preferably, a clamping piece is disposed on the condenser, and a clamping groove is disposed on the condenser fixing base. When the condenser is inserted in the opening and mounted on the base, the clamping piece is clamped and fixed to the clamping groove.

Preferably, the condenser fixing base includes a body, a mounting port is disposed at the center position of the body, a screw base which is disposed around the body is fixed to the back support through a screw. One end of the condenser is inserted through the mounting port and mounted on the base, and the other end of the condenser is provided with a plurality of rotary clamping pieces. The side wall of the mounting port is provided with clamping groove corresponding to the clamping pieces for adjusting positions of the clamping pieces to realize clamping and fixing of the clamping pieces to the clamping groove.

Preferably, the condenser is of a cuboid structure, the clamping pieces are disposed on four corners of one end surface of the cuboid structure respectively. The clamping grooves are disposed on the side wall of the mounting port at positions corresponding to the clamping pieces respectively, each of the clamping grooves is at least provided with a notch towards the center of the mounting port for clamping and fixing the condenser while the clamping piece rotates to the clamping groove.

In the above solution, clamping portions of the clamping pieces can be clamped into the clamping grooves through rotation or can be separated from the clamping grooves through rotation. By disposing the clamping pieces on four corners of one end surface of the cuboid structure respectively, stable fixing of the condenser can be realized.

Preferably, back cover plates are detachably mounted on the back supports and shield the outer surfaces of the back supports.

In the above solution, as the opening is disposed on the back support, thus influencing the appearance of the rear part of the laundry treatment apparatus, thus a back cover plate is detachably disposed on the back support, and the back cover plate shields the opening, thus making the appearance of the complete machine integrated, which is advantageous to perform all-dimensional integrated design for the laundry treatment apparatus.

According to the characteristics of a twin-drum washing machine, disposing the base between the first laundry treatment drum and the second laundry treatment drum saves the internal space of the device for processing clothes. As compared with disposing of the base on the bottom of a clothes drying drum in the prior art, disposing the base between the first laundry treatment drum and the second laundry treatment drum increases the mounting height of the condenser, so as to facilitate mounting and dismounting of the condenser.

Preferably, the part, corresponding to the first laundry treatment drum, of the back of the laundry treatment apparatus is provided with a first back support; and the part, corresponding to the second laundry treatment drum, of the back of the laundry treatment apparatus is provided with a second back support, wherein the opening is disposed in the first back support.

In the above solution, disposing the opening in the first back support can increase the height of the opening and facilitates mounting and dismounting of the condenser by the user.

Preferably, the laundry treatment apparatus is provided with a first back cover plate and a second back cover plate corresponding to the first back support and the second back support respectively, the first back cover plate shields the outer surface of the first back support, and the second back cover plate shields the outer surface of the second back support.

In the above solution, the first back cover plate shields the first back support and also shields the opening in the first back support, while the second back cover plate shields the second back support. And the first back cover plate and the second back cover plate coordinate to shield the back of the entire laundry treatment apparatus. The back face of the laundry treatment apparatus is generally disposed in a manner of facing a wall. Therefore, the requirement on the appearance of the back face of the laundry treatment apparatus is small.

In another aspect, as compared with disposing of one cover plate only, disposing a first back cover plate and a second back cover plate is more advantageous to mount and dismount the condenser by the user. In an actual dismounting process, the user only needs to dismount the first back cover plate for replacement of the condenser, without the need of dismounting the second back cover plate. Therefore, the difficulty for replacing the condenser is greatly reduced.

Preferably, the opening is disposed in an edge at one side of the back support, the base is provided with a condenser mounting cavity corresponding to the opening, and a mounting opening of the condenser mounting cavity is disposed at the rear side of the base and directly faces the opening.

In the above solution, by disposing the opening in the edge at one side of the back support, the condenser is mounted between the first laundry treatment drum and the second laundry treatment drum at a position close to the edge on the left or right side of the laundry treatment apparatus. According to the structures of the first laundry treatment drum and the second laundry treatment drum, it can be known that the gaps of the positions close to the edges of the left and right sides between the first laundry treatment drum and the second laundry treatment drum in the laundry treatment apparatus are the largest. Disposing the opening in the edge at one side of the back support just mounts the condenser at the position, so as to save the internal space of the twin-drum laundry treatment apparatus by fully using the structural characteristics of the twin-drum laundry treatment apparatus.

Preferably, the condenser is of a cuboid structure and is disposed in parallel with the axes of the two laundry treatment drums.

In the above solution, the condenser is designed as a cuboid structure and is disposed in parallel with the axes of the two laundry treatment drums, which further saves the internal space of the laundry treatment apparatus.

Preferably, a condenser cooling air channel is further disposed on the base, and an air inlet of the condenser cooling air channel is disposed at the side face or back face of the laundry treatment apparatus.

In the above solution, by disposing the air inlet of the cooling air channel at the side face or back face of the laundry treatment apparatus, the integral structure of the front panel 10 of the complete machine is similarly reserved to make the front panel 110 integrated, which is advantageous to make the front panel 10 delicate and performs a function of obviously improving the aesthetic property of the laundry treatment apparatus. Meanwhile, it is advantageous to enhance the structural strength of the front panel 10.

The above embodiments described are merely preferred embodiments of the present disclosure, rather than restriction to the present disclosure in any form. Although the preferred embodiments of the present disclosure are disclosed above, they are not used to define the present disclosure. Any person skilled in the art who is familiar with the patent can change or modify the technical content reminded above as equivalent embodiments of equivalent change without departing from the scope of the technical solution of the present disclosure. However, any content without departing from the technical solution of the present disclosure, any simple change, equivalent change and modification made to the above embodiments according to the technical substance of the present disclosure, belong to the scope of the solution of the present disclosure.

1. A laundry treatment apparatus, comprising
a first laundry treatment drum and a second laundry treatment drum disposed up and down,
a front panel located in front of the first laundry treatment drum and the second laundry treatment drum and covering the first laundry treatment drum and the second laundry treatment drum, wherein
a first door and a second door are disposed on the front panel up and down, and a control panel assembly is disposed on at least one of the first door and the second door.

2. The laundry treatment apparatus according to claim 1, wherein the first door or the second door comprises a door body and an observation window mounted at a hollow position on the door body, the door body is provided with a mounting space above the observation window, and the control panel assembly is mounted in the mounting space above the observation window.

3. The laundry treatment apparatus according to claim 1, wherein the door body comprises an outer frame and an inner frame, the outer frame and the inner frame are mounted integrally to constitute a main frame of the first door or the second door, a port is arranged on each of center positions of the outer frame and the inner frame for mounting the observation window, and a groove is arranged in each of the outer frame and the inner frame above the port to form the mounting space for mounting the control panel assembly.

4. The laundry treatment apparatus according to claim 3, wherein the door body further comprises a window screen covering a surface of the outer frame and shielding an outer surface of the first door or the second door, an opening corresponding to the groove in the outer frame is arranged on an upper part of the window screen, and the control panel assembly comprises a control panel mounted in the opening.

5. The laundry treatment apparatus according to claim 4, wherein the control panel assembly comprises a shell with an opening, the control panel disposed at an open end of the shell, and a computer board mounted in the shell, and the control panel extends into the mounting space through the groove in the inner frame and is fixed in the opening of the window screen.

6. The laundry treatment apparatus according to claim 5, wherein an surface of the shell, opposite to the control panel, protrudes outward to form a fixing portion, a surface of circumferential side of the groove in the inner frame is sunk inwards to form a mounting portion for holding and fixing the fixing portion, and the fixing portion is attached to an interior of the mounting portion and fixed to the mounting portion through a fastener.

7. The laundry treatment apparatus according to claim 1, wherein the front panel is of a one-piece tabular structure covering the first laundry treatment drum and the second laundry treatment drum, a mounting space is disposed on the first door, the control panel assembly is embedded in the mounting space and fixed to the first door, and the surface of the control panel assembly is in smooth transition with a surface of the first door.

8. The laundry treatment apparatus according to claim 7, wherein laundry input ports are disposed in the front panel, a circumferential surface of each of the laundry input port is recessed to form a door mounting space, the first door or the second door of the laundry treatment apparatus is embedded in the door mounting space and are connected with the front panel for allowing the laundry input port to be opened or closed, and the first door and the second door of the laundry treatment apparatus, the control panel and the front panel form a smooth front surface of the laundry treatment apparatus.

9. The laundry treatment apparatus according to claim 1, wherein a cross-sectional profile of the front panel from top to bottom is a smooth line gradual transition from a curve to a straight-line segment occurs, surfaces of the doors first door and the second door are in smooth transition with the front panel at the circumferential sides of the doors first door and the second door, and a surface of the control panel assembly is in smooth transition with the surface of the first door.

10. The laundry treatment apparatus according to claim 9, wherein at least a part of the first door is disposed as a curved-surface structure bent towards a back side of the laundry treatment apparatus or a plane structure tilting towards the back side of the laundry treatment apparatus; the control panel assembly is shared by the first laundry treatment drum and the second laundry treatment drum and is disposed on the curved-surface structure or the plane structure.

11. The laundry treatment apparatus according to claim 6, wherein the fixing portion is of a laminar structure, and a thickness of the fixing portion is matched with a depth of the mounting portion sunk inward, so that when the fixing portion is mounted in the mounting portion, a surface of the control panel assembly exposed out of the outer frame is in smooth transition with the surface of the outer frame.

12. The laundry treatment apparatus according to claim 2, wherein the front panel is of a one-piece tabular structure covering the first laundry treatment drum and the second laundry treatment drum, the mounting space is disposed on the first door, the control panel assembly is embedded in the mounting space and fixed to the first door, and the surface of the control panel assembly is in smooth transition with a surface of the first door.

13. The laundry treatment apparatus according to claim 3, wherein the front panel is of a one-piece tabular structure covering the first laundry treatment drum and the second laundry treatment drum, a mounting space is disposed on the first door, the control panel assembly is embedded in the mounting space and fixed to the first door, and the surface of the control panel assembly is in smooth transition with a surface of the first door.

14. The laundry treatment apparatus according to claim 9, wherein the curved-surface structure on the first door is located at an upper part of the first door, the first door is provided with a plane structure or curved-surface structure below the curved-surface structure, the control panel assembly is disposed on the curved-surface structure at the upper part of the first door, and the control panel of the control panel assembly has the same curvature or tilt angle with the surface of the first door at the circumferential side of the control panel assembly.

15. The laundry treatment apparatus according to claim 2, wherein a cross-sectional profile of the front panel from top to bottom is a smooth line gradual transition from a curve to a straight-line segment occurs, surfaces of the first door and the second door are in smooth transition with the front panel at the circumferential sides of the first door and the second door, and a surface of the control panel assembly is in smooth transition with the surface of the first door.

16. The laundry treatment apparatus according to claim 1, wherein at least a part of the first door is disposed as a curved-surface structure bent towards a back side of the laundry treatment apparatus or a plane structure tilting towards the back side of the laundry treatment apparatus; the control panel assembly is shared by the first laundry treatment drum and the second laundry treatment drum and is disposed on the curved-surface structure or the plane structure
